(19) United States
(12) Patent Application Publication
(10) Pub. No.: US 2007/0077972 A1
(43) Pub. Date: Apr. 5, 2007

(54) Hinge assembly for a foldable electronic device

(75) Inventors: Ying-Liang Tu, Shenzhen (CN); Shun Guo, Shenzhen (CN); Chia-Hua Chen, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO., LTD, Shindian City (TW)

(21) Appl. No.: 11/442,408

(22) Filed: May 26, 2006

(30) Foreign Application Priority Data
Sep. 30, 2005 (CN) 200510100061.6

(51) Int. Cl. H04M 1/00

(52) U.S. Cl. 455/575.3

(57) ABSTRACT

A hinge assembly (100) includes a first magnetic member (10), and a second magnetic member (20). The first magnetic member is a hollow tube with an open end. The first magnetic member has a first face (162) and a second face (164) at a first end (122) thereof The first face and the second face have opposing polarities. The second magnetic member is a cylinder. The second magnetic member is received in the first magnetic member in a such a manner as to be rotatable relative to the first magnetic member. The second magnetic member has a third face (242) and a fourth face (244) at a first end thereof adjacent the first end of the first magnetic member. The third face and the fourth face have opposing polarities.

### TECHNICAL FIELD

The present invention relates to hinge assemblies and, particularly, to a hinge assembly for foldable electronic devices, such as mobile telephones, electronic notebooks, and the like.

### BACKGROUND

With the development of wireless communication and information processing technologies, portable electronic devices such as mobile telephones and electronic notebooks are now in widespread use. These electronic devices enable consumers to enjoy high technology services anytime and anywhere. Consumers particularly favor foldable electronic devices due to their convenience and ease of storage.

Generally, foldable electronic devices have most of the electronics in one housing, called the body. The other housing, called the flip cover, normally contains fewer electronic components than the body. Other foldable electronic devices have all the electronics in the body, with the flip cover containing no electronics. Various types of hinge assemblies are used to join a body and a cover of a foldable electronic device, so that the flip cover can unfold up from and fold down upon the body. Manufacturers are constantly seeking to reduce the volume, size and weight of portable foldable electronic devices. Thus, it is desirable that the hinge assembly coupling the body with the flip cover is modularized and miniaturized. A modularized hinge assembly has moving parts such as a cam member, a cam follower, a shaft, and a spring, held together in a unified structure. Either the cam member or the cam follower directly contacts the spring. The structure is easily and quickly attached to the body and the flip cover during mass production. The cam member and the cam follower are kept in contact with each other under the force of the spring.

As the cam follower and the cam member are constantly in contact with each other, sliding friction may be produced between the cam member and the cam follower during relative rotation therebetween. This friction wastes energy (i.e., making opening and/or closing of the device more difficult) and causes abrasion of the cam member and the cam follower. The worn surface can further add to the friction therebetween and may eventually lead to premature malfunction or failure of the hinge assembly. In addition, such a hinge assembly can have many components, thus complicating manufacture. Moreover, during the process of opening and closing of the flip cover of the foldable electronic device, the cam member and the cam follower may undergo quick rotation relative to each other under the spring force of the spring, which may produce a large impact on the flip cover. Damage caused by these impacts may eventually lead to premature malfunction or failure of the foldable electronic device. Furthermore, the machining of cam surface of the cam and the cam follower is complicated.

What is needed, therefore, is a hinge assembly which overcomes above-described shortcomings.

### SUMMARY OF THE INVENTION

In a first preferred embodiment, a hinge assembly includes a first magnetic member, and a second magnetic member. The first magnetic member is a hollow with an open end. The first magnetic member has a first face and a second face at a first end thereof The first face and the second face have opposing polarities. The second magnetic member is a cylinder. The second magnetic member is received in the first magnetic member and rotatable relative to the first magnetic member. The second magnetic member has a third face and a fourth face at a first end thereof adjacent the first end of the first magnetic member. The third face and the fourth face have opposing polarities.

Other advantages and novel features will become more apparent from the following detailed description when taken in conjunction with the accompanying drawings.

### BRIEF DESCRIPTION OF THE DRAWINGS

Many aspects of the hinge assembly can be better understood with reference to the following drawings. The components in the drawings are not necessarily drawn to scale, the emphasis instead being placed upon clearly illustrating the principles of the present hinge assembly. Moreover, in the drawings, like reference numerals designate corresponding parts throughout the several views.

FIG. 1 is an schematic, isometric view of a flip-type mobile phone including a flip cover, a main body, and a hinge assembly, according to a first preferred embodiment, the hinge assembly being shown with dashed lines;

FIG. 2 is an enlarged, exploded, isometric view of the hinge assembly of FIG. 1 including a first magnetic member, and a second magnetic member according to a preferred embodiment;

FIG. 3 is similar to FIG. 2, but showing another aspect;

FIG. 4 is an assembled view of the hinge assembly shown in FIG. 2,

FIG. 5 shows a first relative position of the first magnetic member and the second magnetic member, where the flip cover is maintained at the fully-closed position;

FIG. 6 shows a second relative position of the first magnetic member and the second magnetic member;

FIG. 7 shows a third relative position of the first magnetic member and the second magnetic member;

FIG. 8 shows a fourth relative position of the first magnetic member and the second magnetic member, and

FIG. 9 shows a fifth relative positions of the first magnetic member and the second magnetic member, while the flip cover is maintained at the fully-opened position.

### DETAILED DESCRIPTION OF PREFERRED EMBODIMENTS

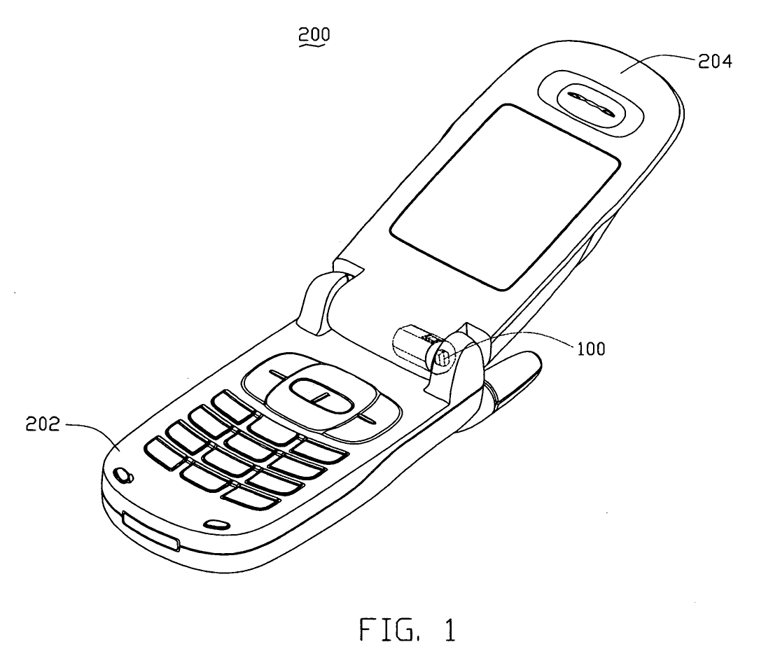

Referring now to the drawings, FIG. 1 shows a foldable electronic device such as a flip-type mobile phone 200, which includes a hinge assembly 100, according to a first preferred embodiment. The mobile phone 200 has a main body 202 and a flip cover 204. The main body 202 and the flip cover 204 are pivotally connected to each other via the hinge assembly 10. It should be noted that the hinge assembly 100 may also, for example, be used to interconnect components like a main body and a flipping section of any other kind of device, other than the mobile phone 200.

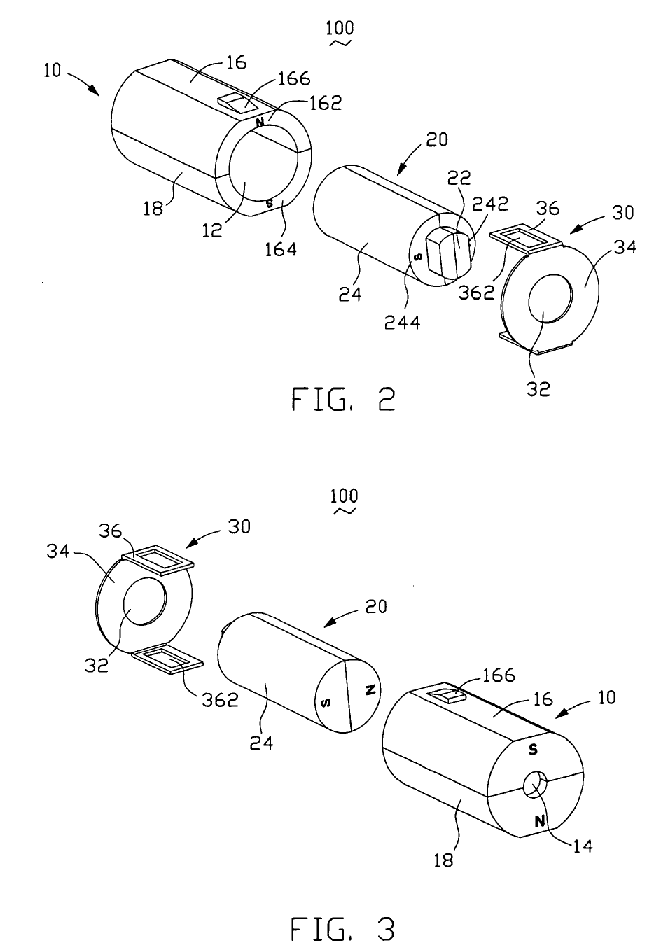

Referring now to FIGS. 2-3, the hinge assembly 100 includes a first magnetic member 10, a second magnetic member 20, and a locking member 30.

The first magnetic member 10 is a hollow cylinder with a cavity 12 defined therein. The first magnetic member 10 has a first end 122 and a second end 124. The first end 122 is an open end, and the second end 124 is a half-closed end with a hole 14 defined in a central area thereof and in communication with the cavity 12. The first magnetic member 10 includes two opposing planar surfaces 16 and two opposing arcuate surfaces 18 formed at an outer periphery thereof The first magnetic member 10 is connected with the flip cover 202 via the planar surfaces 16. One end of the first magnetic member 10 can be divided into two or more faces. The adjacent faces of the first magnetic member 10 have opposing polarities. For example, in this embodiment, the first end 122 of the first magnetic member 10 is divided into a first face 162, and a second face 164. The first face 162 of the first magnetic member 10 forms a north (N) magnetic pole, and the second face 164 forms a south (S) magnetic pole. Since a magnetic member has north and south magnetic poles, the second end 124 of the first magnetic member 10 has two faces having opposing magnetic poles, with north and south corresponding to the first face., and the second face, respectively. The first magnetic member 10 has two wedge-shaped latching blocks 164, with one formed on each of the two planar surfaces 16, for latching the locking member 30.

The second magnetic member 20 is a cylinder. The second magnetic member 20 includes a securing portion 22 and a cylinder portion 24 connecting with the securing portion 22. The securing portion 22 is connected with the body 204 of the mobile phone 200. A diameter of the cylinder portion 24 is equal to or slightly less than an inner diameter of the first magnetic member 10 such that the cylinder portion 24 of the second magnetic member 20 can be received in the cavity 12 of the first magnetic member 10. One end of the cylinder portion 24 also can be divided into two or more faces. The adjacent faces of the second magnetic member 20 have opposing polarities. For example, in this embodiment, an end of the cylinder portion 24 adjacent to the securing portion 22 is divided into a third face 242, and a fourth face 244. The third face 242 of the second magnetic member 20 forms a north (N) magnetic pole, and the fourth face 244 forms a south (S) magnetic pole.

The locking member 30 includes a sheet-like portion 34 with a central hole 32, and two opposing locking arms 36 extending in parallel in the same direction from an outer periphery of the sheet-like portion 34. The securing portion 22 of the second magnetic member 20 can pass through the central hole 32. Each locking arm 36 defines a rectangular opening 362 such that the latching block 166 can securely engage in the opening 362.

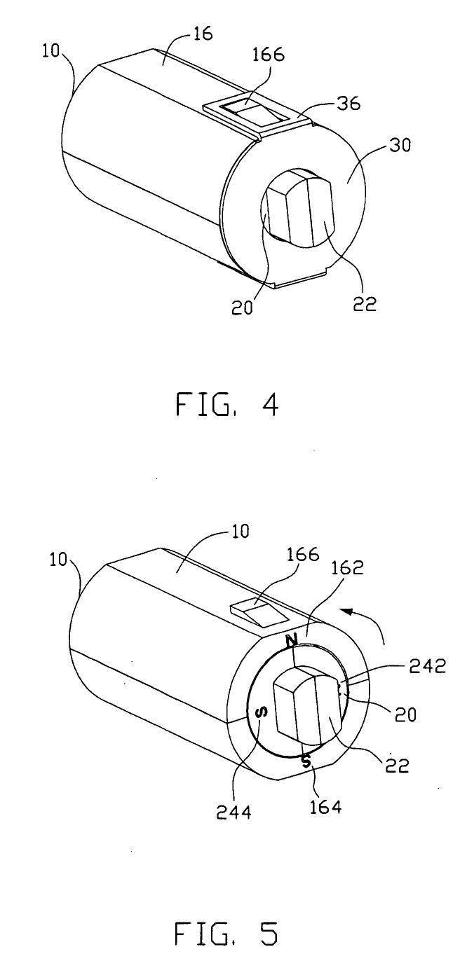

Referring to FIG. 4, in assembly, the second magnetic member 20 is mounted in the cavity 12 of the first magnetic member 10, with the securing portion 22 extends out of the first end 122 of the first magnetic member 10. The locking member 30 covers the first end 122 of the first magnetic member 10, with the securing portion 22 of the second magnetic member 20 extending through the central hole 32 of the locking member 30. The latching blocks 166 of the first magnetic member 10 securely engage in the openings 362, thus preventing the second magnetic member 20 from becoming separated from the first magnetic member 10.

Referring to FIG. 4, in use, the first magnetic member 10 is engaged (i.e. operatively located/fixed) in a cavity (not shown) of the flip cover 204 of the mobile phone 200 via the planar surfaces 16, and cannot rotate relative to the flip cover 204. The securing portion 22 of the second magnetic member 20 is engaged in the main body 202 of the mobile phone 200, and cannot rotate relative to the main body 202. FIG. 5 shows a first relative position of the first magnetic member 10 and the second magnetic member 20, where the flip cover 204 is in a fully-closed position relative to the main body 202. In this state, the first face 162, the third face 242, the second face 164 and the fourth face 244 are arranged so as to be separated by 90-degree angles from each other. Meanwhile, the magnetic forces, as denoted by the direction of the arrow in FIG. 5, give the first magnetic member 10 a tendency to rotate relative to the second magnetic member 20 in a counter-clock wise direction, as denoted by the direction of the arrow in FIG. 5, which maintains the flip cover 204 in a fully-closed position relative to the main body 202.

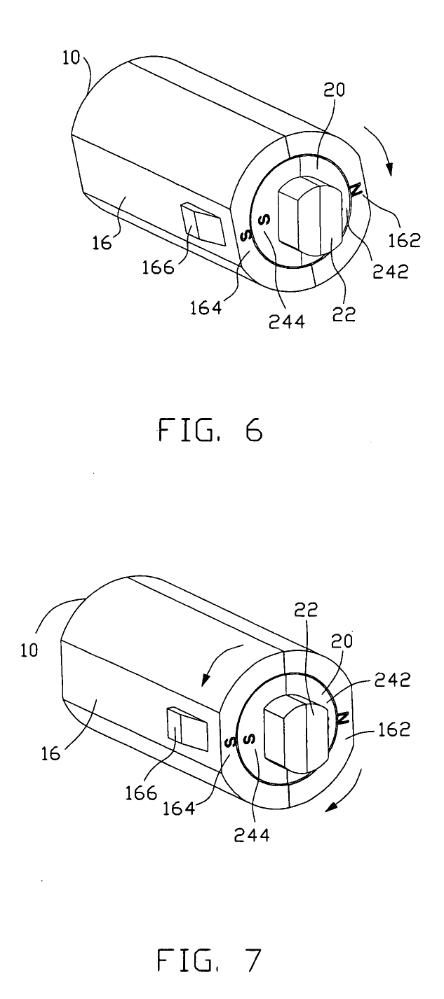

Referring to FIG. 6, if a user opens the flip cover 204 to rotate the first magnetic member 10 in a clockwise direction, as denoted by the direction of the arrow in FIG. 6, the first face 162 will approach the third face 242 and move away from the fourth face 244. If the external force is removed, the repulsive force (between the first face 162 and the third face 242, and between the second face 164 and the fourth face 244) will drive the first face 162 back to the state shown in FIG. 5. If the first magnetic member 10 keeps rotating until it reaches 90 degrees as shown in FIG. 7, the first face 162 and the third face 242, the second face 164 and the fourth face 244, having the same polarity, are disposed opposing each other. Meanwhile, the repulsive force forces the first magnetic member 10 and the second magnetic member 20 to reach a stable state. Accordingly, 90-degrees is a critical angle in the preferred embodiment.

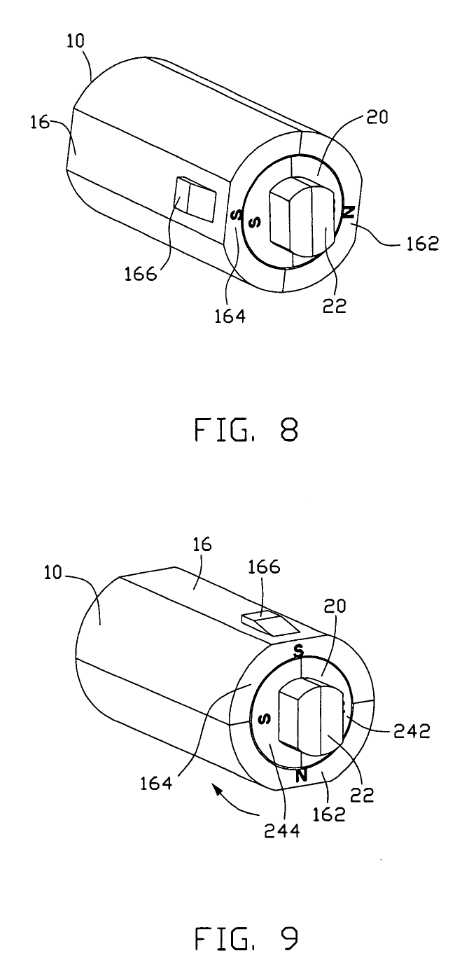

If an external force is continuously applied to the first magnetic member 10 to rotate the first magnetic member 10 through the critical angle as shown in FIG. 7, then the first face 162 is repelled by the third face 242 and attracted by the fourth face 244. If the external force is terminated at this moment, then the first magnetic member 10 automatically keeps rotating until the first face 162, the third face 242, the second face 164 and the fourth face 244 are arranged so as to be separated by 90-degree angles from each other again as shown FIG. 8. The flip cover 204 is therefore rotated to a fully-opened position. In this state, the magnetic forces, as denoted by the direction of the arrow in FIG. 8, gives the first magnetic member 10 a tendency to rotate relative to the second magnetic member 20 in a clockwise direction as shown in FIG. 8. The structures of the flip cover 204 and the main body 202 can therefore control the range of rotation of the hinge assembly 100, such that the first magnetic member 10 is located at a 180-degree position.

In an alternative embodiment, each locking arm 36 may be designed to have a locking blocks protruding therefrom, the first magnetic member 10 also having two spaced openings defined in an outer periphery thereof Each locking block of the locking arm being configured to engage in a corresponding opening of the first magnetic member. In addition, the locking member 30 can be omitted. The second magnetic member 20 may be prevented from becoming separated from the first magnetic member 10 via the main body 202 of the mobile phone 200. The planar surface 16 may be replaced by other fixing means such as a protrusion or a groove formed on an outer periphery of the first magnetic member 10.

The first magnetic member 10 and the second magnetic member 20 of the present hinge assembly could be chosen from the group consisting of permanent magnets, electromagnets, or other materials possessing magnetism.

In the embodiments described above, a main advantage is that it has only three main components, and occupies a relatively small volume. Accordingly, the space required in an application such as the mobile phone 200 is reduced. In addition, when the second magnetic member 20 is received in the first magnetic member 10, there is a clearance between the first magnetic member 10 and the second magnetic member 2, so that no sliding friction is produced between the first magnetic member 10 and the second magnetic member 20. The magnetic material adopted in the embodiment does not wear out easily with time and has no issue of elasticity decay. Therefore, the durability of the hinge assembly is greatly increased.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hinge assembly, comprising:
a first magnetic member being a hollow with an open end, the first magnetic member having a first face and a second face at a first end thereof, the first face and the second face having opposing polarities; and
a second magnetic member being a cylinder, the second magnetic member received in the first magnetic member and rotatable relative to the first magnetic member, the second magnetic member having a third face and a fourth face at a first end thereof adjacent the first end of the first magnetic member, the third face and the fourth face having opposing polarities.

2. The hinge assembly as claimed in claim 1, further comprising a locking member disposed at the open end of the first magnetic member so as to prevent the second magnetic member from becoming separated from the first magnetic member.

3. The hinge assembly as claimed in claim 2, wherein the locking member includes a sheet-like portion covering the open end of the first magnetic member.

4. The hinge assembly as claimed in claim 3, wherein the locking member further comprises two spaced locking aims extending in parallel in the same direction from an outer periphery of the sheet-like portion.

5. The hinge assembly as claimed in claim 4, wherein each locking arm defines an opening, the first magnetic member has two spaced latching blocks protruding from an outer periphery thereof, the latching blocks engaging in the openings of the locking aims.

6. The hinge assembly as claimed in claim 4, wherein each locking arm has a locking block protruding from thereof, the first magnetic member has two spaced openings defined in an outer periphery thereof, with each locking block of the locking arm engaging in one corresponding opening of the first magnetic member.

7. A hinge assembly for a foldable electronic device having a main body and a flip cover, the hinge assembly comprising, comprising:
a first magnetic member being hollow with an open end, the first magnetic member having a plurality of faces at a first end thereof, the adjacent faces of the first magnetic member having opposing polarities, the first magnetic member being configured so as to be fixed relative to one of the main body and the flip cover; and
a second magnetic member being a cylinder with a securing portion formed at first end thereof, the second magnetic member being received in the first magnetic member and rotatable relative to the first magnetic member, the second magnetic member having a plurality of faces at the first end thereof adjacent to the first end of the first magnetic member, the adjacent faces of the first magnetic member have opposing polarities, the securing portion being configured so as to be fixed relative to the other of the main body and the flip cover.

8. The hinge assembly as claimed in claim 7, further comprising a locking member disposed at the open end of the first magnetic member so as to prevent the second magnetic member from becoming separated from the first magnetic member.

9. The hinge assembly as claimed in claim 8, wherein the locking member includes a sheet-like portion covering the open end of the first magnetic member.

10. The hinge assembly as claimed in claim 9, wherein the locking member further comprises two spaced locking arms extending in parallel in the same direction from an outer periphery of the sheet-like portion.

11. The hinge assembly as claimed in claim 10, wherein each locking arm defines an opening, the first magnetic member has two spaced locking blocks protruding from an outer periphery thereof, and the locking blocks engage in the openings of the locking arms.

12. The hinge assembly as claimed in claim 10, wherein each locking arm has locking blocks protruding therefrom, the first magnetic member has two spaced openings defined in an outer periphery thereof, each locking block of the locking arm engaging in a corresponding opening of the first magnetic member.

13. The hinge assembly as claimed in claim 10, wherein the first magnetic member has a fixing portion formed on an outer periphery thereof, the fixing portion being configured so as to be fixed in the one of the main body and the flip cover.

14. The hinge assembly as claimed in claim 13, wherein the fixing portion is two opposing planar surfaces.

15. A foldable electronic device, comprising:
a main body;
a flip cover; and
a hinge assembly joining the flip cover to the main body, the hinge assembly including:
a first magnetic member being a hollow with an open end, the first magnetic member having a first face and a second face at a first end thereof, the first face and the second face having opposing polarities, the first magnetic member having a fixing portion being configured so as to be fixed with the one of the main body and the flip cover;
a second magnetic member being a cylinder with a securing portion formed at one end thereof, the second magnetic member received in the first magnetic member and rotatable relative to the first magnetic member, the second magnetic member having a third face and a fourth face at a first end thereof adjacent the first end of the first magnetic member, the third face and the fourth face having opposing polarities, the second magnetic member having a securing portion being configured so as to be fixed relative to the other of the main body and the flip cover.

16. The hinge assembly as claimed in claim 15, further comprising a locking member disposed at the open end of the first magnetic member so as to prevent the second magnetic member from becoming separated from the first magnetic member.

17. The hinge assembly as claimed in claim 16, wherein the locking member includes a sheet-like portion covering the open end of the first magnetic member, and two spaced locking arms extending in parallel in the same direction from an outer periphery of the sheet-like portion.

18. The hinge assembly as claimed in claim 17, wherein each locking arm defines an opening, the first magnetic member has two spaced locking blocks protruding from an outer periphery thereof, the locking blocks engaging in the openings of the locking aims.
